(19) United States
(12) Patent Application Publication
(10) Pub. No.: US 2004/0190937 A1
(43) Pub. Date: Sep. 30, 2004

(54) Toner cartridge for an image forming apparatus

(76) Inventors: Christopher Paul Mercer, Hong Kong (HK); Samuel Tsui Wai Keung, Hong Kong (HK)

Correspondence Address: Thomas P. Liniak, Liniak, Berenato & White, Suite 240, 6550 Rock Spring Drive, Bethesda, MD, 20817, US

(21) Appl. No.: 10/751,121

(22) Filed: Jan. 5, 2004

(30) Foreign Application Priority Data
Jan. 10, 2003 (GB) 0300629.3

(51) Int. Cl. G03G 15/00

(52) U.S. Cl. 399/117

(57) ABSTRACT

A toner cartridge for use in a electrophotographic imaging machine comprises a photosensitive drum, process means acting upon the photosensitive drum and a rotating shaft which extends to the whole length of the drum along the drum's axis. A mounting component is provided which supports the photosensitive drum on the shaft, the mounting component producing electrical continuity between the inside surface of the photosensitive drum and the shaft.

The present invention relates to an electrophotographic toner cartridge, including a photosensitive member and process means, detachably mounted in an apparatus for forming images, hereinafter described as a toner cartridge.

The concept of a removable toner cartridge was disclosed in U.S. Pat. No. 3,985,436 which discloses a copying apparatus in which the serviceable parts, including a photosensitive member and a developer unit, are mounted in a casing which can be easily withdrawn and removed from the main unit in order that service of the consumable parts might take place.

U.S. Pat. No. 4,538,896 discloses a toner cartridge which is intended to be completely discarded after use and replaced with a new one. This allows the user to perform a preventive maintenance task without specialised assistance from a service technician.

Accordingly in the art, a toner cartridge is designed to contain those elements, central to the xerographic process, which wear or are consumed within the selected preventative maintenance period. These include toner or developer, which are entirely consumed. Other components include an electrophotographic drum or belt; developer roller; triboelectric charging blade, drum or belt; cleaning blade; and developer roller; all of which wear or are consumed to some degree during the life of the toner cartridge. light source for erasing remaining charge on the electrophotographic drum or belt and a transfer roller for transferring the developed image from the drum or belt and on to paper or other media. The decision as to whether these and other elements would be contained in the toner cartridge would depend on the expected life or preventative maintenance interval of those components relative to the life of the toner or developer which is fully consumed. Another factor is the cost of the component as the user would not wish to replace high cost items unnecessarily.

Within a toner cartridge of this type, various components including the drum or belt and the developer roller, are required to rotate. In the art the rotation force is provided by an electric motor which is not included inside the toner cartridge. The motor is usually provided as part of the imaging apparatus (“host machine”) because it is regarded as a long lasting component of relatively high cost. In addition the motor must be quite rugged to provide the torque necessary to drive the rotating elements within the toner cartridge. As well as inherent frictions, there are blades which are forced against the rotating components which act against the rotation of those components. These may include a triboelectric charging blade acting against the rotation of the developer roller and a cleaning blade acting against the electrophotographic drum or belt.

Hence in the art there is a provided a coupling between the host machine and the toner cartridge which transmits a rotational driving force of fairly high Inherent in all the above designs is the fact that the rotational elements of the toner cartridge are driven from one axial end of the electrophotographic drum. This driving method is likely to impose twisting and torsional forces on the elements inside the toner cartridge, thus affecting their precisely set relationship.

The present invention utilises a shaft extending all the way along the axial length of the drum to receive drive from the host machine. This drive is then transmitted from the shaft to various rotating elements of the imaging system.

An advantage of the invention is the effective transmission of a high torque without imparting undue twist on the toner cartridge or the photosensitive drum contained within the cartridge.

Another aspect of the invention is the use of an aluminium end-piece to support the photosensitive drum at at least one end. This enables a high precision assembly and also provides a conductive path from the inside of the drum to the shaft and thence to a machine ground.

The invention will now be described by way of example with reference to the accompanying drawings in which:

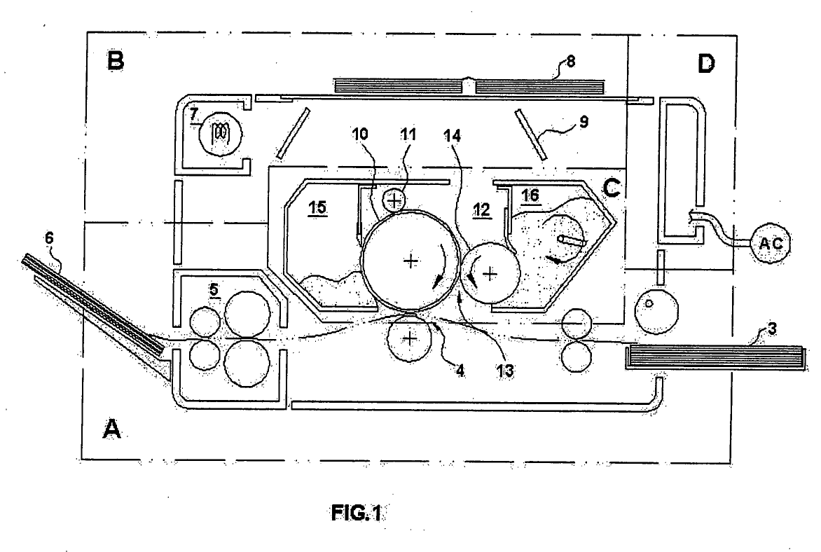

FIG. 1 is a schematic of a typical known electrophotographic copier or printer.

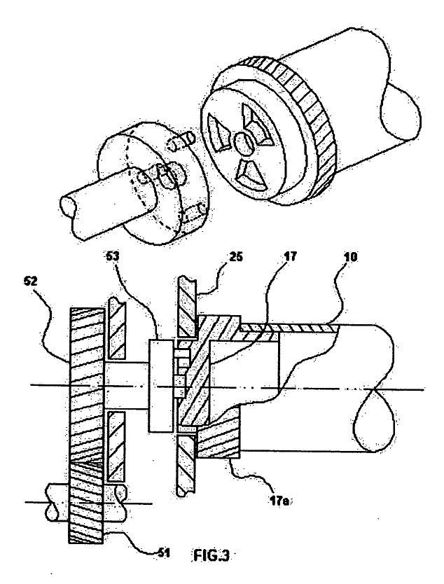

FIG. 3 is a schematic and perspective of a prior art pin coupling drive arrangement

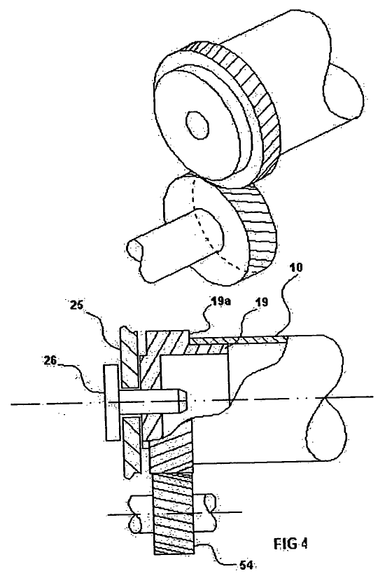

FIG. 4 is a schematic and perspective of a prior art helical gear arrangement

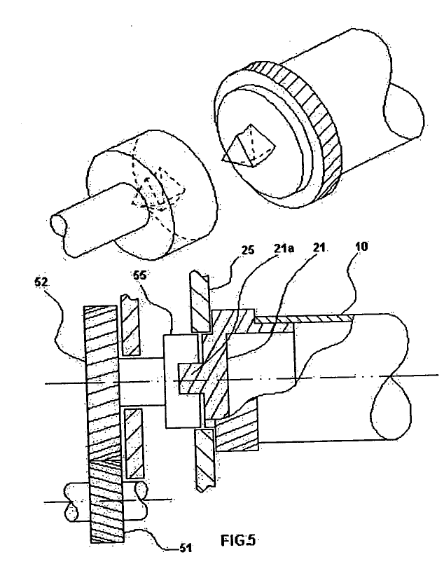

FIG. 5 is a schematic and perspective of a prior art axially driven arrangement using a twisted triangular recess driving a twisted triangular projection.

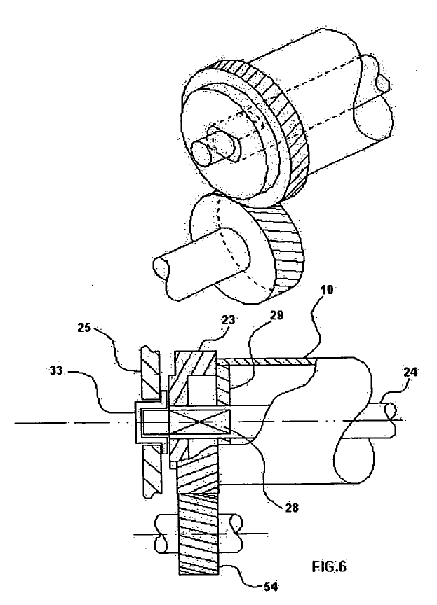

FIG. 6 is a simplified schematic and perspective showing drive transmission to a central shaft of a toner cartridge of a first embodiment of the current invention

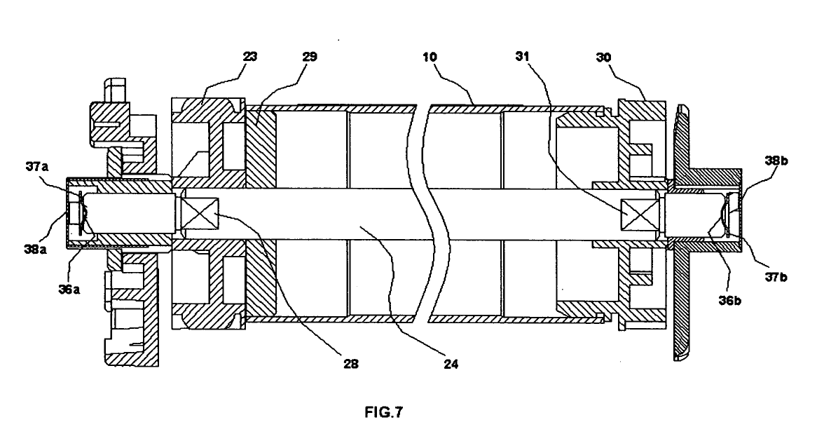

FIG. 7 is a cross section of a toner cartridge of the first embodiment showing the full length of a shaft and electrophotographic drum arrangement.

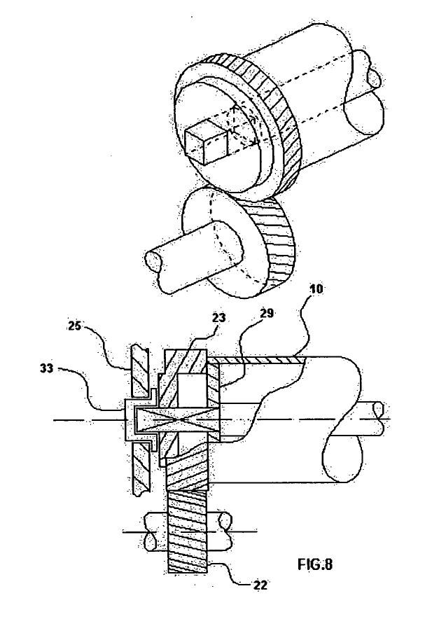

FIG. 8 shows an alternative shaft arrangement where the driven end of the shaft is square cut;

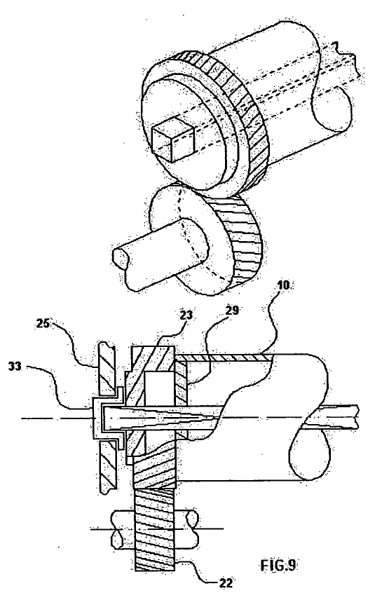

FIG. 9 shows an embodiment of the current invention incorporating a shaft of square cross section driven system where the driven shaft is of circular section with a driven pin to receive rotational force;

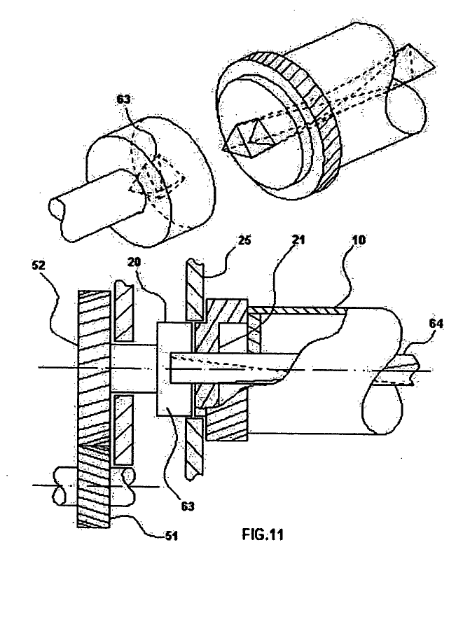

FIG. 11 is a further embodiment of an axially driven system, this time driven by a twisted triangular recess, the driven correspondent member being a twisted shaft of triangular cross section;

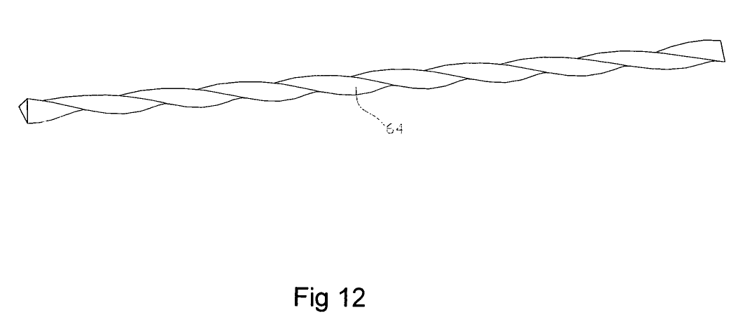

FIG. 12 is a perspective view of the shaft employed in FIG. 11.

### TECHNOLOGY BACKGROUND

This invention relates to a toner cartridge which forms a part of an image forming apparatus and contains process means for forming an electrophotographic image on a photosensitive drum and which in normal use would be replaced by unskilled users. The image forming apparatus may be an electrophotographic copier; a laser beam printer; a fax machine; or a combination of either or all of these. The process means may comprise a magnetic brush system for transporting mono- or dual component developer from locations in one or more hoppers to a developing station whereby the developer and/or toner is presented to a latent image on the photosensitive drum. Other process means may comprise the charging mechanism for the photosensitive drum; the transfer mechanism; and/or the cleaning mechanism.

With reference to FIG. 1, an image forming apparatus such as an electrophotographic copying machine can be divided into four sections. The so-called base engine (A) comprises the paper handling mechanisms which feed the paper from a storage cassette (3) through an image receiving section (4) to a fixing unit (5) which employs temperature and pressure to fix the image onto the receiving medium. There is then an output tray (6) to which the medium is fed. The second section is the image forming section (B) which comprises a light source (7) illuminating an image to be copied (8), this illumination being reflected off the subject image through an optical system (9) and finally focused on to a photosensitive drum (10). The photosensitive drum is part of the third main section which may be termed the xerographic section (C). The drum (10) is charged by a charging device (11) prior to exposure to said light image. Having rotated past the image receiving section (12) where the charged surface is selectively discharged to form an electrical version of the image (latent image) the surface of the photosensitive drum passes a development zone (13) where a layer of toner and/or developer (14) is exposed to the latent image and electrostatic and/or magnetic forces cause the toner to transfer to the surface of the drum in the pattern of the latent image. The drum rotates further to a transfer section (4) where electrical and/or electrostatic forces cause the toner to transfer to the receiving medium. Any toner or developer remaining on the drum is cleaned off at a cleaning station (15). The fourth section, D, of such a copying device is the control electronics which comprise power supplies and controllers for supervising the various operations of the machine.

(In digital applications such as laser beam printers or digital copiers, section B differs in that a laser beam is used to generate the light image. The beam is modulated or pulsed to form “light dots” which are scanned in a raster fashion across the photosensitive drum. Section D differs in that substantial hardware and software might be dedicated to image preparation and rasterisation of the page image. Sections A and C can be very similar to the electrophotographic copier described above).

In this embodiment many of the consumable items of the machine are contained in section C. Section C comprises a removable toner cartridge which may be removed by the user (a) during the life of the toner cartridge to clear paper jams or to exchange for a toner cartridge containing toner of a different colour; or (b) when the toner powder contained in the hopper (16) is exhausted and the user either discards the toner cartridge or (preferably) returns the toner cartridge for refurbishing and recharging.

### Prior Art Cartridge Drive Systems

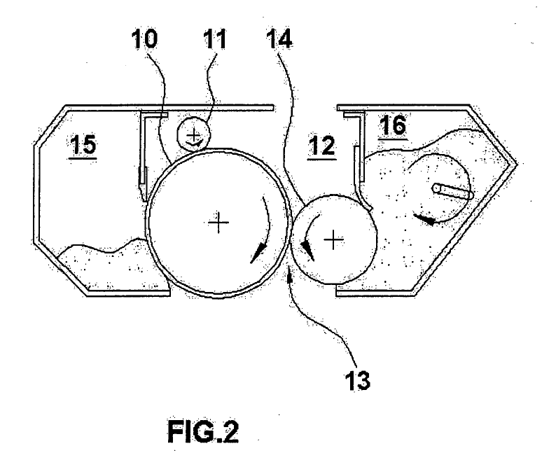

A schematic of a typical prior art toner cartridge (equivalent to the elements of section C in FIG. 1 and showing the same numbering) is shown in section in FIG. 2. The directions of rotation of the various process elements are indicated. In the prior art the drum can be driven from the host machine by a pin coupling (FIG. 3); a helical gear (FIG. 4); or a non circular axial projection (FIG. 5). In all three cases the first recipient of the drive force from the host machine is a flange inserted and fixed into one end of the electrophotographic drum. Typically this flange is fabricated by injection moulding a resin such as polycarbonate or acetal or any other engineering grade injection mouldable resin.

In FIG. 3 the drum flange (17) is rotationally mounted in the casing (25) of the toner cartridge and is driven axially by pins (53) projecting from a gear unit (52) in the host machine. Gears 51 and 52 are caused to rotate by an unshown electric motor in the host machine and thus the drive pins (53) drive the electrophotographic drum in the toner cartridge via the flange (17) which is rigidly fixed into one end of the electrophotographic drum using a strong adhesive. Around the periphery of flange (17) a helical gear (17a) is cut which serves to transmit the driving force to a developer roller (not shown) inside the cartridge.

The cartridge is mounted into the host machine in a direction axial with the drum such that the electrophotographic drum in the cartridge engages with the coupling pins. The pins might be spring loaded so that if the drive protrusions are initially not aligned, they can spring into place as the electric motor starts to rotate the driving assembly.

FIG. 4 is another example of the prior art. However in this case the electrophotographic drum (10) in the cartridge casing (25) is driven radially. Like the flange (17) in FIG. 3, the flange (19) in FIG. 4 has a helical gear (19a) around the periphery, but which this time serves two purposes: firstly to receive drive from a helical drive gear (54) in the host machine; and secondly to transmit this drive to an unshown developer roller in the cartridge.

In the case of FIG. 4 the cartridge is loaded in a direction transverse to the axis of the drum, such that the driving gear (54) engages the driven flange (19). One of the gears has enough play to ensure smooth loading.

FIG. 5 is a further prior art example where the electrophotographic drum (10) is driven axially. In this case the driving member (55) in the host machine has a twisted triangular recess which engages a twisted triangular projection (21a) moulded integrally with the the drum flange (21). As with FIG. 3 the cartridge is loaded in the axial direction and the driving member might have to be spring loaded such that the drive train can rotate until the correct engagement position is found.

First Embodiment of Current Invention

FIG. 6 shows an embodiment of the current invention wherein the driven element in the cartridge is in the form of a shaft which extends entirely through the centre of the drum along the axis of the drum. The shaft (24) is mounted in the toner cartridge casing (25) at either end in a manner which allows the shaft to rotate relative to the casing. One or both ends of the shaft is supported in a bushing (33) which may be conductive in order to keep the shaft earthed, through sliding contact with a grounded contact in the host machine (not shown).

Drive from the host machine is transmitted radially via a driving gear (54) which communicates with a driven gear (23) in the cartridge. The driven gear is mounted onto the shaft in such a way that the drive is transmitted to the shaft. This can be achieved by cutting one or more flats (28) on the shaft and profiling the bore of the gear (23) to fit onto the shaft such that within the limits of constructional tolerances there is substantially no relative rotation between gear and shaft.

The toner cartridge is mounted into the host machine in a direction transverse to the axis of the electrophotographic drum (10). The host machine's driving gear (54) meshes with the cartridge's helical gear (23) and drive is thus imparted to the shaft when the motor in the host machine (not shown) is switched on. The speed of rotation of the shaft is dictated by the host machine's motor speed and the gear ratio.

The general cross section of the shaft in this embodiment is circular except for flat portion(s) (28) machined onto the shaft to enable drive to be transmitted from the helical gear to the shaft.

FIG. 7 shows a cross section of both ends of such a system, but also showing at both ends a different bearing arrangement incorporating earthing of the shaft and hence the photosensitive drum. The drive to the cartridge's photosensitive drum is transmitted via a flange (30) at the opposite end of the drum from the drive-receiving end of the shaft. The flange (30) is injection moulded from a polycarbonate or other engineering plastic which may be glass filled and in this embodiment contains a gear on its outer circumference (the portion not inserted into the drum) to transmit drive from the shaft to a transfer roller in the host machine (not shown). The flange is a press fit into the drum and a sliding fit on the shaft. A D-shape in the inner bore of the flange locates onto a portion of the shaft machined with a flat (31) in order that the drum and the transfer roller may be driven.

The photosensitive drum (10) is mounted onto the shaft by the above flange (30) and at the other end by means of a metal disk (29). It will be noted that there is no relative movement between the drum and the shaft because they are both rotating at the same speed. In this embodiment the end of the drum nearest the helical gear (23) is supported by a centre-drilled metal disk (29) which is a press fit into the internal diameter of the drum and a sliding fit on the shaft. The functions of this disk are firstly to conduct charge from the inside wall of the drum to the host machine's ground via the shaft and the contact arrangements at an end of the shaft; and secondly to support the drum in a position precisely concentric with the shaft. Preferably the disk should be fabricated from the same material as the drum substrate (e.g. aluminium) to eliminate any differential expansion or contraction under the influence of ambient heat or cold. The disk can be a machined component or it can be pressed out of sheet metal or drawn into a cup shape.

In this way the torsion generated by the driving resistance of the cartridge system is borne by the shaft and not by the electrophotographic drum as in the prior art systems.

A summary of the drive transmission system is as follows:

Host machine motor and drive gear (54) to cartridge helical gear (23) in FIGS. 6 and 7

Helical gear (23) to shaft (24) using D-flat principle

Helical gear (23) to developer roller drive gear in cartridge (not shown)

Shaft (24) to flange (30) in opposite end of the electrophotographic drum using D-flat principle

Flange (30) to photosensitive drum (10) using press fit or gluing of flange into inner diameter of photosensitive drum.

Flange (30) to transfer roller in host machine (not shown) via transfer roller drive gear

Other rotational elements which might be driven directly from the shaft include a toner stirring system but this is not detailed here.

Grounding of the Inner Surface of the Photosensitive Drum

As part of the xerographic operation the photosensitve coating on the drum is charged and then by the action of selected points of light, discrete areas of the photosensitive coating become conductive and the charge conducts to the inner surface of the drum, from where it needs to be provided with a path to ground.

In this embodiment the metal washer (29) provides a conductive path from the inner surface of the drum to the shaft. There is then a facility at each end of the shaft to provide electrical continuity with a contact in the host machine at either end of the shaft according to the electrical layout determined by the machine's designers.

Referring to FIG. 7, the two ends of the shaft are centre drilled with shallow recesses (36a and 36b respectively). These recesses receive a dimpled portion (37a and 37b respectively) of the contact piece which may be press formed from steel or berillium copper or a similar conductive material which is easy to press form. As the shaft rotates the recess revolves around the dimpled contact portion which self centres by rotational friction and is held against the end of the shaft by the inherent spring force of the material. The dimpled portions are connected to cap portions (38a and 38b respectively) which contact against an axial spring loaded contact (not shown) in the host machine.

A summary of the photosensitive drum grounding system is as follows:

Charge is applied to the outer photosensitive surface of the drum

Charge is conducted to the inner surface of the drum when selectively stimulated by light

Charge is conducted from the drum (10) to the shaft (24) via the metal washer (29) which is a press and sliding fit respectively between them

Charge can be conducted to either of the axial ends of the shaft to contacts (36a ) or (36b )

Contacts (36a ) or (36b ) are contiguous with conductive end caps (38a ) and (38b ) respectively

According to host machine design, charge is conducted from end caps (38a ) and/or (38b ) to the ground contact(s) provided by the host machine for this purpose

Charge flows to mains ground via the host machine's power transmission system

In this system the diameter of the drum would range from 24 mm to 30 mm and the shaft diameter would range from 3 mm to 10 mm. However it is envisaged that the same construction could be applied both to larger and smaller systems. The rotational speed of the shaft in this embodiment would typically be in the order of 50 to 150 revolutions per minute.

Further Embodiments—Gear Driven Systems

Although the above embodiment employs a round shaft with D-shaped portions at the positions where rotational drive is received or transmitted, a round shaft with square sections might be employed to equal effect (FIG. 8). With a square cross section it is easier to transmit and receive rotational driving force but carefull attention must be paid to bushings and supporting parts to ensure concentricity and ease of rotation. Note in FIG. 8 that the bushing (33) would rotate in a bearing portion of cartridge casing (25).

FIG. 9 illustrates a similar system but in this embodiment the cross section of the shaft along its entire length is square.

Axially Driven Systems

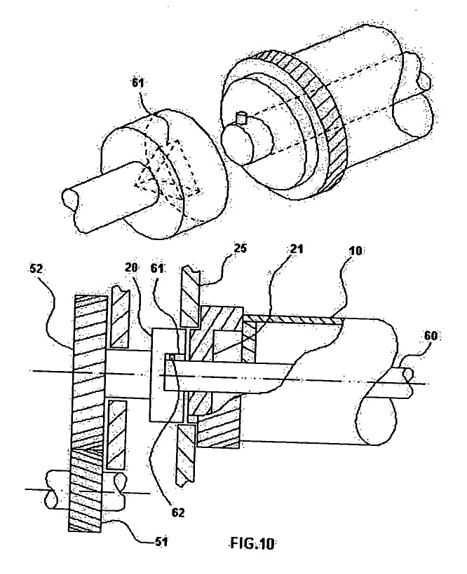

Another embodiment is shown in FIG. 10 where a shaft of circular cross section (60) is employed but this time the drive from the host machine is imparted axially via a non circular recess (61) on board a driving boss which in turn is driven by gears (51 and 52) in the host machine. The non-circular driving recess (61) has a maximum inscribed diameter corresponding to slightly more than the diameter of the through-shaft (60). A pin (62) engages with an element of the non-circularity to enable a rotational driving force to be transmitted to the shaft.

A further embodiment is shown in FIG. 11. In this embodiment the driving recess is in the form of a twisted triangular rhomboid (63) and the through-shaft (64) receiving this drive has a triangular cross section and is twisted along its entire length with a degree of twist corresponding to that of the driving recess. According to this arrangement the shaft fits exactly into the recess and concentricity is assured even when the triangular cross section of the shaft is slightly less than that of the recess. The shaft (64) may be fabricated in steel by a swaging method.

A perspective view of the shaft is shown in FIG. 12.

1. A toner cartridge for use in an electrophotographic imaging machine, comprising a photosensitive drum, process means acting upon the photosensitive drum, a rotating shaft which extends through the whole length of the drum along the drum's axis, and a mounting component which supports the photosensitive drum on the shaft, the mounting component providing electrical continuity between the inside surface of the photosensitive drum and the shaft.

2. A toner cartridge according to claim 1 where the shaft supports the photosensitive drum at both ends.

3. A toner cartridge according to claim 1 where the photosensitive drum rotates at the same speed as the shaft.

4. A toner cartridge according to claim 1 where the cartridge includes a casing and the shaft is rotatably mounted in the casing of the toner cartridge.

5. A toner cartridge according to claim 1 where the main body of the shaft is circular in cross section.

6. A toner cartridge according to claim 1 where the shaft is of substantially square cross section.

7. A toner cartridge according to claim 1 where the shaft is of substantially triangular cross section

8. A toner cartridge according to claim 7 where the shaft is twisted along the axial length.

9. A toner cartridge according to claim 1 where the shaft is arranged to receive a rotational driving force at one end from a driving component in the host machine which is coaxial with the shaft.

10. A toner cartridge according to claim 1 where the shaft is arranged to receive a rotational driving force at one end from a driving component in a host machine which has an axis offset from the shaft axis and where the drive is transmitted from the driving component to the shaft by a gear train.

11. A toner cartridge according to claim 1 where the shaft supports gears at either end and connects them such that they are rotatably locked with one another.

12. A toner cartridge according to claim 11 where the gear at one end is driven by drive means external to the cartridge and the gear at the other end drives the photosensitive drum or a component which is external to the toner cartridge.
